(19) United States
(12) Patent Application Publication
(10) Pub. No.: US 2012/0249754 A1
(43) Pub. Date: Oct. 4, 2012

(54) ELECTRONIC APPARATUS, DISPLAY CONTROL METHOD FOR VIDEO DATA, AND PROGRAM

(76) Inventor: Aiko Akashi, Oume-shi (JP)

(21) Appl. No.: 13/346,423

(22) Filed: Jan. 9, 2012

(30) Foreign Application Priority Data
Mar. 31, 2011 (JP) 2011-080235

(51) Int. Cl. H04N 13/04

(52) U.S. Cl. 348/51; 348/E13.026

(57) ABSTRACT

One embodiment provides an electronic apparatus, including: a display controller configured to perform a display control of video data, the video data including a main video and a sub video which are assigned in different time zones; and a detector configured to detect whether the main video or the sub video is currently to be displayed, wherein the display controller performs the display control so as to perform a 3D display of the video data when the detector detects that the main video is currently to be displayed, and perform a 2D display of the video data when the detector detects that the sub video is currently to be displayed.

CROSS-REFERENCE TO RELATED APPLICATION(S)

This application claims priority from Japanese Patent Application No. 2011-080235 filed on March 31, the entire contents of which are incorporated herein by reference.

### FIELD

Embodiments described herein relate generally to an electronic apparatus for displaying a 3D video on a display unit, a display control method for video data, and a program.

### BACKGROUND

There are provided a variety of video display apparatuses capable of performing a 3D display. In such a video display apparatus, a user is allowed to sense a 3D video (multilevel video) with, for example, a video for the left eye and a video for the right eye generated to provide a binocular parallax. When the user watches the 3D video having the strong depth-feeling effect, he/she sometimes feels the fatigue of the eyes.

There is proposed an apparatus capable of converting a 2D (two-dimensional) video into a 3D (three-dimensional) video and/or converting a 3D video into a 2D video, while considering the fatigue of the eyes caused by the 3D video having the strong depth-feeling effect (refer to, for example, JP-2006-121553-A).

There is also proposed a display apparatus in which an inputted composite video signal is converted into a 2D video signal, the inputted signal is converted into a 3D video signal in accordance with the motion magnitude of the 2D video signal, and the 2D video signal and the 3D video signal are selectively changed-over (refer to, for example, JP-H07-281644-A).

Generally, the viewer wants to maximally view the 3D display while suppressing the fatigue of the eyes.

However, in JP-H07-281644-A, since a 2D display and a 3D display are changed-over in accordance with a motion magnitude when displaying a video, the video could not be maximally viewed in the 3D display, and the user may fail to view the 3D display of a part of the video.

### BRIEF DESCRIPTION OF DRAWINGS

A general architecture that implements the various features of the present invention will now be described with reference to the drawings. The drawings and the associated descriptions are provided to illustrate embodiments and not to limit the scope of the present invention.

FIG. 1 illustrates an electronic apparatus according to one embodiment.

FIG. 2 illustrates a system configuration of the electronic apparatus of the embodiment.

FIG. 3 illustrates a functional configuration for displaying a video content data in the electronic apparatus of the embodiment.

FIG. 4 illustrates a process for generating a 3D video from video content data in the electronic apparatus of the embodiment.

FIG. 5 conceptually illustrates the display control of the embodiment.

### DETAILED DESCRIPTION

In general, one embodiment provides an electronic apparatus, including: a display controller configured to perform a display control of video data, the video data including a main video and a sub video which are assigned in different time zones; and a detector configured to detect whether the main video or the sub video is currently to be displayed, wherein the display controller performs the display control so as to perform a 3D display of the video data when the detector detects that the main video is currently to be displayed, and perform a 2D display of the video data when the detector detects that the sub video is currently to be displayed.

Now, an embodiment will be described with reference to the drawings.

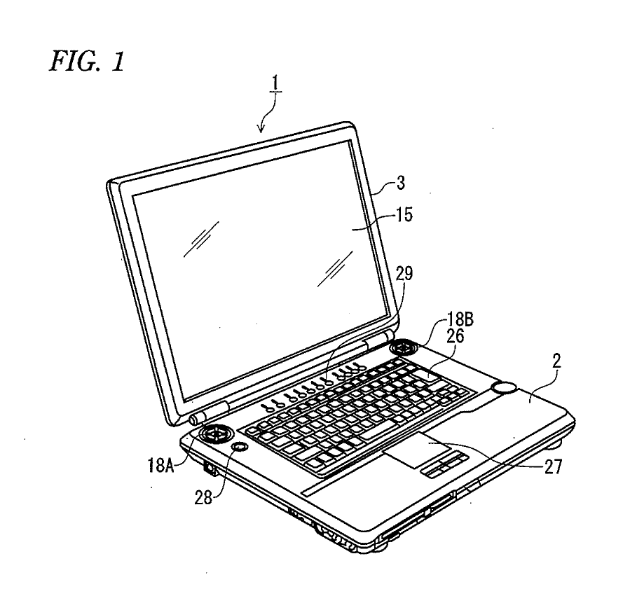

FIG. 1 illustrates an electronic apparatus according to one embodiment. The electronic apparatus is realized as a personal computer 1 of, for example, notebook type. As shown in FIG. 1, the computer 1 is configured of a computer body 2 and a display unit 3.

In the display unit 3, an LCD (liquid crystal display) 15 is built. The display unit 3 is attached to the computer body 2 so as to be rotatable between its open position at which the upper surface of the computer body 2 is exposed and its closed position at which the upper surface of the computer body 2 is covered.

The computer body 2 has a thin box-shaped housing, and a keyboard 26, a power button 28 for turning ON/OFF the power source of the computer 1, an input manipulation panel 19, a touchpad 27, loudspeakers 18A and 18B, etc. are arranged on the upper surface of the housing. Various manipulation buttons, such as manipulation buttons for controlling television (TV) functions (viewing, video recording, and the reproduction of video-recorded TV broadcast data/video data), are disposed on the input manipulation panel 29. At the front of the computer body 2, a remote controller interface 30 for communicating with a remote controller which is capable of remotely controlling the TV function of the computer 1 is provided. The remote controller interface 30 is configured of, for example, an infrared-signal receiver.

An external display connection terminal (not shown) compatible with, for example, an HDMI (high-definition multimedia interface) standard is provided at, for example, the rear of the computer body 2. The external display connection terminal is used for outputting to an external display, video data (motion picture data) contained in video content data such as TV broadcast data.

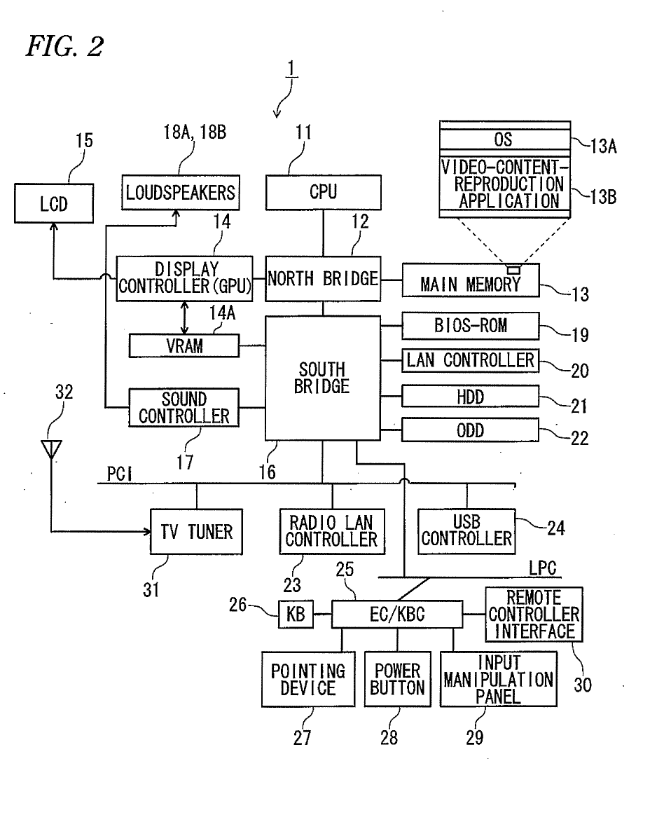

FIG. 2 illustrates a system configuration of the computer 1.

As shown in FIG. 2, the computer 1 includes a CPU 11, a north bridge 12, a main memory 13, a display controller 14, a video memory (VRAM) 14A, an LCD (Liquid Crystal Display) 15, a south bridge 16, a sound controller 17, loudspeakers 18A and 18B, a BIOS-ROM 19, a LAN controller 20, a hard disk drive (HDD) 21, an optical disk drive (ODD) 22, a radio LAN controller 23, a USB controller 24, an embedded controller/keyboard controller (EC/KBC) 25, a keyboard (KB) 26, a pointing device 27, a power button 28, an input manipulation panel 29, a remote controller interface 30, a TV tuner 31, a TV broadcast reception antenna 32, etc.

The CPU 11 controls the operation of the computer 1. This CPU 11 runs an operating system (OS) 13A and a video-content-reproduction application program 13B and the like application program as are loaded from the HDD 21 into the main memory 13. The video-content-reproduction application program 13B is software for displaying video content data. This video-content-reproduction application 13B executes a live reproduction process for displaying the TV broadcast data received by the TV tuner 31, a video recording process for recording the received TV broadcast data in the HDD 21, a reproduction process for reproducing the TV broadcast data/video data recorded in the HDD 21, a reproduction process for reproducing the video content data received through a network, etc. Further, the video-content-reproduction application 13B has the function for displaying a 3D video. The video-content-reproduction application 13B converts 2D (two-dimensional) video data contained in the video content data, into 3D (three-dimensional) video data in real time and displays the 3D video data on the screen of the LCD 15. Besides, the video-content-reproduction application 13B converts 3D video data contained in the video content data, into 2D video data in real time and displays the 2D video data on the screen of the LCD 15.

The conversion into the 3D video data and the conversion into the 2D video data can be realized by employing various known methods (refer to, for example, 7P-2006-121553-A). For example, a shutter scheme (time division scheme) may be employed for the 3D video display. In the 3D video display of the shutter scheme, a stereo pair video which contains video data for the left eye and video data for the right eye is used.

The LCD 15 is driven at a refresh rate (for example, 120 Hz) which is, for example, double an ordinary refresh rate (for example, 60 Hz). Left eye frame in the video data for the left eye, and right eye frame in the video data for the right eye are alternately displayed on the LCD 15 at a refresh rate of, for example, 120 Hz. A user can watch the left eye frame image with the left eye, and the right eye frame image with the right eye, by employing 3D glasses (not shown), for example, liquid-crystal shutter glasses. The 3D glasses may be so configured that synchronizing signals which indicate the display timings of the respective frame data for the left eye and for the right eye are received from the computer 1 by employing infrared radiation or the like. A shutter for the left eye and a shutter for the right eye within the 3D glasses are opened and shut in synchronism with the display timings of the respective frame data for the left eye and for the right eye, for the LCD 15.

A polarization scheme, for example, “Xpol” (registered trademark) scheme may be employed for the display of the 3D video instead of the shutter scheme. In this case, interleave frame groups in which the left eye image and the right eye image, for example, are interleaved in, for example, scanning line units are generated, and these interleave frame groups are displayed on the LCD 15. A polarization filter which covers the screen of the LCD 15 polarizes the left eye image as is displayed in the groups of, for example, odd-numbered lines and the right eye image as is displayed in the groups of even-numbered lines, on the screen of the LCD 15, in different directions. The user can watch the left eye image with the left eye, and the right eye image with the right eye, by employing polarization glasses.

A lenticular scheme or a parallax scheme in which a stereo image can be watched with the naked eyes may be employed for the display of the 3D image.

Also, the CPU 11 runs a BIOS (Basic Input/Output System) which is stored in the BIOS-ROM 19. The BIOS is a program for a hardware control.

The north bridge 12 connects the local bus of the CPU 11 and the south bridge 16. A memory controller for access-controlling the main memory 13 is also built in the north bridge 12. The north bridge 12 also has the function of executing communications with the display controller 14.

The display controller 14 is a device for controlling the LCD 15 which is used as the display unit of the computer 1. A display signal which is generated by the display controller 14, is sent to the LCD 15. The LCD 15 displays a video based on the display signal.

The south bridge 16 controls individual devices on a PCI (Peripheral Component Interconnect) bus and an LPC (Low Pin Count) bus. An IDE (Integrated Drive Electronics) controller for controlling the HDD 21 and the ODD 22, and a memory controller for access-controlling the BIOS-ROM 19 are built in the south bridge 16. Further, the south bridge 16 has the functions of executing communications with the sound controller 17 and the LAN controller 20.

The sound controller 17 is a sound source device, which outputs audio data to-be-reproduced to the loudspeakers 18A and 18B. The LAN controller 20 is a wired communication device which executes wired communications of, for example, “Ethernet” (registered trademark) standard, whereas the radio LAN controller 23 is a radio communication device which executes radio communications of, for example, IEEE 802.11 standard. The USB controller 24 executes communications with an external apparatus through a cable of, for example, USB 2.0 standard.

The EC/KBC 25 is a one-chip microcomputer in which an embedded controller for performing power management, and a keyboard controller for controlling the keyboard (KB) 26 and the pointing device 27 are integrated. This EC/KBC 25 has the function of turning ON/OFF the power of the computer 1 in accordance with the user's manipulation for the power button 28. Further, the EC/KBC 25 has the function of executing communications with the remote controller interface 30.

The TV tuner 31 is a reception device which receives the TV broadcast data broadcasted by a TV broadcast signal, through the TV broadcast reception antenna 32. This TV tuner 31 is realized as a digital TV tuner which can receive the digital TV broadcast data of, for example, a digital terrestrial TV broadcast. The TV tuner 31 also has the function of capturing video data inputted from the external apparatus. The TV broadcast reception antenna 32 may be attached outside the apparatus, or may be built in the computer 1.

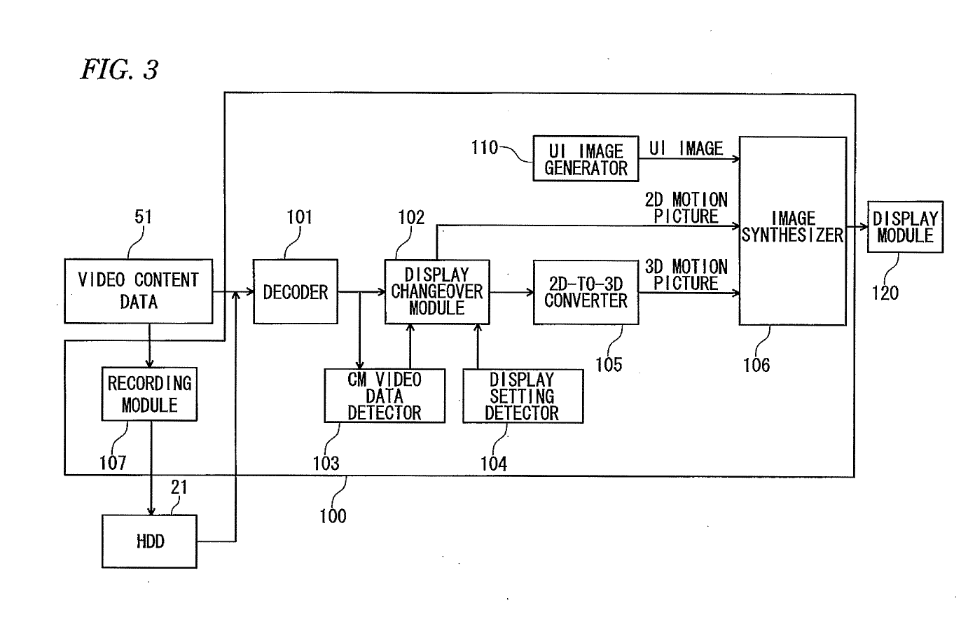

Next, a video content reproduction function in the embodiment will be described with reference to FIG. 3. The video content reproduction function is fulfilled by a controller 100. The control of the controller 100 is a control by the CPU 11 which runs the video-content-reproduction application program 13B. This control is not restrictive, but the control of the controller 100 may be performed together with another device, or it may be performed only by a hardware control which does not accompany a software control.

Video content data to-be-reproduced 51 contain, for example, video data for displaying a video (motion picture). The video content data 51 is the TV broadcast signal which has been received through the TV broadcast reception antenna 32 and the tuner 31. The video data in the video content data 51 are outputted to a decoder 101. These video data have generally undergone coding (compression coding). The decoder 101 decodes the coded video data. The decoder 101 outputs decoded video data to a display changeover module 102. The display changeover module 102 outputs the decoded video data to a 2D-to-3D converter 105 or an image synthesizer 106. Usually, the display changeover module 102 outputs the decoded video data to the image synthesizer 106. As will be stated later, the display changeover module 102 changes-over whether the decoded video data are to be outputted to the 2D-to-3D converter 105 or to the image synthesizer 106, based on detection results from a display setting detector 104 and a CM (commercial) video data detector 103.

The display setting detector 104 detects whether the 3D display of the video content data or the 2D display thereof (the release of the 3D display) has been selected (set) by the user, and it notifies the detection result to the display changeover module 102. Here, the “setting of the 3D display” signifies a case where 3D reproduction has been set through a manipulation by the user, or a case where 3D reproduction is automatically performed when the video content data to be displayed are 3D video content data. The “setting of the 2D display” signifies a case where the 2D reproduction has been set through a manipulation by the user, or a case where 2D reproduction is automatically performed when the video content data to be displayed are 2D video content data.

The CM video data detector 103 detects whether the video content data (TV broadcast data) under view have been changed-over from program video data to CM video data or vice versa, and it notifies the detection result to the display changeover module 102.

The detection of the changeover by the CM video data detector 103 is done by referring to broadcast information contained in the TV broadcast data to-be-viewed as have been obtained from the TV broadcast signal (refer to, for example, JP-2010-252377-A). The detection may be done in accordance with the existence of a specified image which is inserted between the program video data and the CM video data. Also, the detection of a CM may be done by comparing the video content data with CM video data which were received in the past and which are kept stored.

Here, the “CM video data” signify the contents of commercials, whereas the “program video data” signify the contents of news, sports, dramas, music, variety programs, movies, etc.

The 2D-to-3D converter 105 analyzes respective image frames contained in the video data by using the decoded video data, thereby to presume the depth of every pixel contained in each of the image frames. Using the presumed depth of every pixel, the 2D-to-3D converter 105 converts the video data into 3D video data. The 3D video data contain image data for the left eye and image data for the right eye as have a parallax based on, for example, the depth of every pixel within the image frame and a set parallax angle. The 2D-to-3D converter 105 outputs the 3D video data to a display module 120.

A user-interface (UI) image generator 110 generates user-interface image data (UI image data) such as menu items for manipulating the video content data 51 (video displayed on the screen). The UI image generator 110 outputs the generated UI image data to the image synthesizer 106. A 3D reproduction button for giving the instruction of the display of the 3D video is included in the user interface.

The image synthesizer 106 synthesizes a UI image, and the 3D video or the video data decoded by the decoder 101. Specifically, when the 3D video is inputted, the image synthesizer 106 generates the left eye frame by using the image data for the left eye and the UI image data. The image synthesizer 106 generates the right eye frame by using the image data for the right eye and the UI image data. The image data stated above may be ones having been generated as image layers, respectively. The image synthesizer 106 generates the image frame by superposing the image layers with, for example, alpha blending. The image synthesizer 106 outputs the generated left eye and right eye image frames to the display module 120. When the video data decoded by the decoder 101 are inputted, the image synthesizer 106 generates the image frame by using the video data and the UI image data.

When the left eye and right eye image frames are inputted, the display module 120 alternately displays on the screen (the LCD 15), the left eye frame and the right eye frame as have been outputted from the image synthesizer 106. As stated above, the user can perceive the 3D image by watching the screen with, for example, the liquid-crystal shutter glasses. The display module 120 may display on the screen, an interleave image in which the left eye frame and the right eye frame are interleaved in scanning line units. In that case, the user can perceive the 3D image by watching the screen with, for example, the polarization glasses. When the image frames generated from the video data and the UI image data are inputted, the display module 120 displays the image frames on the screen (the LCD 15) one after another.

A recording module 107 executes a process for recording the video content data in the HDD 21. The video content data recorded in the HDD 21 are outputted to the decoder 101 in accordance with the instruction of the user or the like.

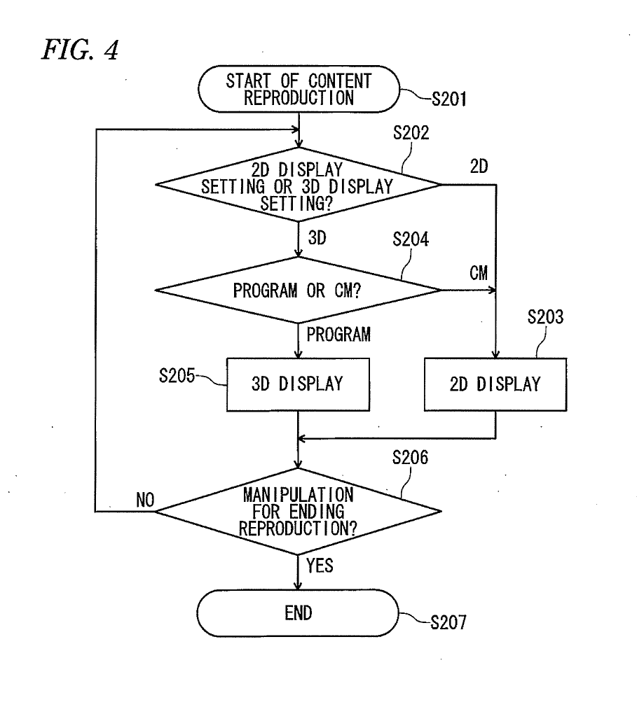

Next, the process for generating the 3D video from the video content data will be described with reference to FIG. 4.

When a manipulation for displaying the TV broadcast data has been performed by the user, a TV broadcast data display process is started (step 201).

The display setting detector 104 detects whether the 2D display of the TV broadcast data or the 3D display thereof is set, and the process proceeds to a step 203 in case of the setting of the 2D display (the 2D display at a step 202). Further, the display setting detector 104 outputs the decoded TV broadcast data to the image synthesizer 106. The display changeover module 102 outputs the decoded video data to the image synthesizer 106, and the display of the 2D video is started in the display module 120 through a process in the image synthesizer 106 (step 203).

On the other hand, when the 3D display of the TV broadcast data is set at the step 202, the process proceeds to a step 204 (the 3D display at the step 202).

Subsequently, at the step 204, the CM video data detector 103 detects whether the TV broadcast data under view are to display the program video data or to display the CM video data (step 204). This CM video data detector 103 notifies the information of the detection result to the display changeover module 102. The display changeover module 102 changes-over whether the decoded TV broadcast data are to be outputted to the 2D-to-3D converter 105 or to the image synthesizer 106, based on the detection result.

In case of the display timing of the program video data (the program at a step 204), the display changeover module 102 outputs the decoded TV broadcast data to the 2D-to-3D converter 105, and the display of the 3D video is started by the display module 120 through a process in the image synthesizer 106 (step 205), whereupon the process proceeds to a step 206.

In case of the display timing of the CM video data (the CM at the step 204), the display changeover module 102 outputs the decoded TV broadcast data to the image synthesizer 106, and the display of the 2D video is started by the display module 120 through a process in the image synthesizer 106 (step 203), whereupon the process proceeds to the step 206.

When a manipulation for ending the display of the TV broadcast data has been performed by the user (“Yes” at the step 206), the display of the TV broadcast data is ended (step 207). On the other hand, when the manipulation for ending the display of the TV broadcast data has not been performed (“No” at the step 206), the process proceeds to the step 202.

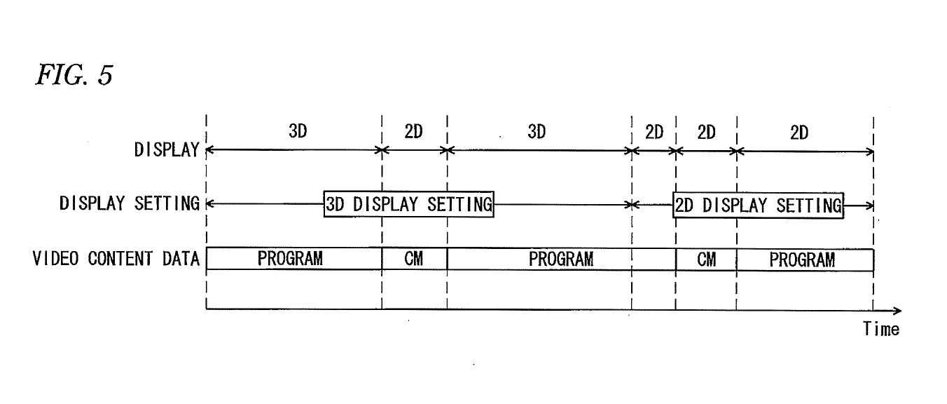

Next, the 2D display and the 3D display of the video content data will be described with reference to FIG. 5.

The video content data are such that the program video data and the CM video data are alternately displayed in time sequence. When the display setting is the 2D display setting, the 2D display is presented regardless of the sorts of the program video data and the CM video data. On the other hand, when the display setting is the 3D display setting, the 3D display is presented at the display timing of the program video data, and the 2D display is presented at the display timing of the CM video data.

When the CM video data of the TV broadcast data program are displayed, the 2D display is presented, whereby the user can be restrained from feeling the fatigue of the eyes.

Although the TV broadcast data based on the TV broadcast signal has been exemplified as the source of the video content data, video content data recorded in the HDD 21 may be used. The source of the video content data may be video content data which are recorded in a Digital Versatile Disc (DVD) or a “Blu-ray” (registered trademark) disc, and which have main video data (for example, the movie body) corresponding to the foregoing “program video data” and sub video data (for example, the CM video). In this case, the 3D display is presented for the movie body, and the 2D display is presented for the CM video.

Although the case where the video content data to be reproduced and displayed are the 2D video data has been exemplified, video content data to be reproduced and displayed may be 3D video data. In this case, program video data in the 3D video data are displayed as a 3D video without executing a 2D conversion process, and CM video data in the 3D video data are displayed as a 2D video by executing a 3D-to-2D conversion process.

Although the case where the program video data have been displayed by the 3D video and the CM video data have been displayed by the 2D video are exemplified, some temporal deviation may occur. For example, the 3D video display may be changed-over to the 2D video display several seconds after the display timing of the CM video data has been reached, and the 2D video display may be changed-over to the 3D video display several seconds before the display timing of the program video data is reached.

Although the personal computer of notebook type is exemplified as the electronic apparatus, as the embodiment may be adapted to a television receiver, a video tape recorder, a DVD recorder or a “Blu-ray” recorder.

The techniques stated in the individual embodiments can also be distributed by being stored in a storage medium such as a magnetic disc (flexible disc, hard disc or the like), an optic disc (CD-ROM, DVD or the like), a magnetooptic disc (MO) or a semiconductor memory, in the form of programs that can be run by a computer.

The storage medium may be in any storage aspect as long as it can store the programs therein, and it is a computer-readable one.

Also, an OS (operating system) running on the computer, or MW (middleware) such as database management software or network software, may execute parts of the individual processes for incarnating the embodiment, based on the instructions of the programs installed in the computer from the storage medium.

Further, the storage medium in the present invention is not restricted to the medium independent of the computer, but it will cover a storage medium into which the programs transmitted by a LAN, the Internet or the like have been downloaded to be stored or temporarily stored.

The storage medium is not restricted to the single medium, but even a case where the processes in the embodiment are executed using plural media will be covered within the storage medium in the present invention, and a medium configuration may be any configuration.

While the computer in the embodiment is to execute the individual processes, based on the programs stored in the storage medium, and it may be in any configuration such as a single apparatus which is formed of the personal computer etc., or a system in which plural apparatuses are connected as a network.

The functions of the individual modules described in the above embodiments may be realized by software applications which are run by the processor, by processing circuits which are based on hardware, by hardware, or by combining software applications, hardware and software modules.

Although the several embodiments have been described, these embodiments are examples, and they are not intended to restrict the scope of the invention. The novel embodiments can be carried out in various other aspects, and they can be subjected to varieties of omissions, replacements and alterations within a scope of the invention. These embodiments and the modifications thereof will fall within the scope of the appended claims and a scope equivalent thereto.

1. An electronic apparatus, comprising:
a display controller configured to perform a display control of video data, the video data including a main video and a sub video which are assigned in different time zones; and
a detector configured to detect whether the main video or the sub video is currently to be displayed,
wherein the display controller performs the display control so as to
perform a 3D display of the video data when the detector detects that the main video is currently to be displayed, and
perform a 2D display of the video data when the detector detects that the sub video is currently to be displayed.

2. The electronic apparatus of claim 1, further comprising:
a display setting module configured to allow the user to set the 2D display or the 3D display;
wherein, when the 2D display is set by the display setting module, the display controller performs the 2D display of the video data, regardless of a detection result of the detector.

3. The electronic apparatus of claim 1,
wherein the main video is program video data, and
wherein the sub video is commercial video data.

4. A method for performing a display control of video data, the video data including a main video and a sub video which are assigned in different time zones, the method comprising:
detecting whether the main video or the sub video is currently to be displayed;
performing the display control so as to
perform a 3D display of the video data when it is detected that the main video is currently to be displayed, and
perform a 2D display of the video data when it is detected that the sub video is currently to be displayed.

5. A computer-readable medium storing a program for causing a computer to execute a display control of video data, the video data including a main video and a sub video which are assigned in different time zones, the display control comprising:
detecting whether the main video or the sub video is currently to be displayed;
performing the display control so as to
perform a 3D display of the video data when it is detected that the main video is currently to be displayed, and
perform a 2D display of the video data when it is detected that the sub video is currently to be displayed.
